(19) United States
(12) Patent Application Publication
(10) Pub. No.: US 2007/0149052 A1
(43) Pub. Date: Jun. 28, 2007

(54) Displayer mounting device for vehicle

(76) Inventor: Hsiu-Chu Hsu Li, Jubei City (TW)

Correspondence Address: CHARLES E. BAXLEY, ESQ., 90 JOHN STREET, THIRD FLOOR, NEW YORK, NY, 10038, US

(21) Appl. No.: 11/317,554

(22) Filed: Dec. 24, 2005

(51) Int. Cl. H01R 13/648

(52) U.S. Cl. 439/607

(57) ABSTRACT

A displayer mounting device includes a receptacle for attaching to a vehicle and for acting as a headrest for the vehicle, a display, and a moving device for moving the display relative to the receptacle, to selectively move the display out of the receptacle for operating purpose, or for selectively moving the display into the receptacle for storing purpose. A housing is slidably received in the receptacle for supporting the display. A driving device may be used to move the housing relative to the receptacle. The display is preferably pivotally attached to the housing with an axle. The receptacle includes one or more stops for limiting the housing to slide relative to the receptacle.

### BACKGROUND OF THE INVENTION

1. Field of the Invention

The present invention relates to a displayer mounting device, and more particularly to a displayer mounting device for attaching or mounting video monitors or video players or displayers to passenger vehicles without occupying spaces of the passenger vehicles.

2. Description of the Prior Art

Typical displayers or video monitors or video players are normally received in a principle case which is then attached or mounted onto the seat backs or the headrests of the passenger vehicles, for allowing the users or the passengers of the vehicles to view or to play TV, VCR, CRT, VCD, DVD within the passenger vehicles.

For example, U.S. Pat. No. 6,092,705 to Meritt discloses one of the self-contained cases for housing, transporting and mounting video monitor and video player for use in passenger vehicles, and comprises one or more mounting straps attached onto the self-contained cases for attaching or mounting the video monitor and video player to the seat backs and the headrests of the passenger vehicles.

However, the self-contained cases may occupy a large space of the passenger vehicles, particularly the tiny space between the seat backs and the rear cabin or seats for passengers of the passenger vehicles, such that the passengers may not feel comfortable within the tiny rear cabin of the passenger vehicles.

U.S. Pat. No. 6,216,927 to Meritt discloses an entertainment accessory for releasably mounting or securing in passenger vehicles, and also comprises one or more mounting straps attached onto a self-contained case for attaching or mounting the entertainment accessory to the headrests of the passenger vehicles.

However, similarly, the self-contained case may also occupy a large space of the passenger vehicles, particularly the tiny space between the seat backs and the rear cabin or seats for passengers of the passenger vehicles, such that the passengers also may not feel comfortable within the tiny rear cabin of the passenger vehicles.

The present invention has arisen to mitigate and/or obviate the afore-described disadvantages of the conventional displayer mounting devices.

### SUMMARY OF THE INVENTION

The primary objective of the present invention is to provide a displayer mounting device for attaching or mounting video monitors or video players or displayers to passenger vehicles without occupying spaces of the passenger vehicles and without affecting the seating of the passengers within the passenger vehicles.

The other objective of the present invention is to provide a displayer mounting device for forming or acting as the headrest of the passenger vehicles.

The further objective of the present invention is to provide a displayer mounting device including a display movable into and out of the headrest.

In accordance with one aspect of the invention, there is provided a displayer mounting device for attaching to a vehicle, the displayer mounting device comprising a receptacle for attaching to the vehicle and for acting as a headrest for the vehicle, and including a chamber formed therein, a display, and a moving device for moving the display relative to the receptacle, to selectively move the display out of the chamber of the receptacle for operating purpose, or for selectively moving the display into the chamber of the receptacle for storing purpose.

The moving device includes a housing slidably received in the chamber of the receptacle, the display is attached to the housing, and a driving device for driving the housing to move relative to the receptacle.

The display is pivotally attached to the housing with at least one axle for allowing the display to be rotated relative to the housing. The housing includes at least one stud having a cavity formed therein for receiving the axle and for pivotally attaching the display to the housing.

The receptacle includes at least one stop extended into the chamber thereof, the housing includes at least one tongue for engaging with the stop and for limiting the housing to slide relative to the receptacle. The housing includes at least one spring-biased catch having the tongue extended out through the housing and for engaging with the stop of the receptacle.

The receptacle includes at least one rail extended into the chamber thereof, the housing includes at least one bar for engaging with the rail and for guiding the housing to slide-relative to the receptacle.

The driving device includes a rack disposed in the receptacle, a reduction gear disposed in the housing and engaged with the rack of the receptacle, and a rotating device for rotating the reduction gear to move and to slide the housing relative to or into and out of the receptacle.

The rotating device includes a motor attached to the housing and engaged with the reduction gear for rotating the reduction gear and for reducing the rotational speed between the housing and the receptacle.

The motor includes a spindle and may include an engaging member attached to the spindle for engaging with the reduction gearing. The housing includes an opening for exposing the reduction gearing and for allowing the reduction gearing to be engaged with the rack.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a displayer mounting device in accordance with the present invention;

FIG. 2 is a partial exploded view of the displayer mounting device as seen from the upper and front portion of the displayer mounting device;

FIG. 3 is another partial exploded view of the displayer mounting device similar to FIG. 2;

FIG. 4 is a further partial exploded view of the displayer mounting device as seen from the lower and front portion of the displayer mounting device;

FIG. 5 is a rear perspective view of a displayer;

FIG. 6 is an enlarged partial perspective view illustrating a driving device of the displayer mounting device;

FIG. 7 is a side schematic view of the displayer mounting device, and

FIG. 8 is a side schematic view similar to FIG. 7, illustrating the operation of the displayer mounting device.

### DETAILED DESCRIPTION OF THE PREFERRED EMBODIMENT

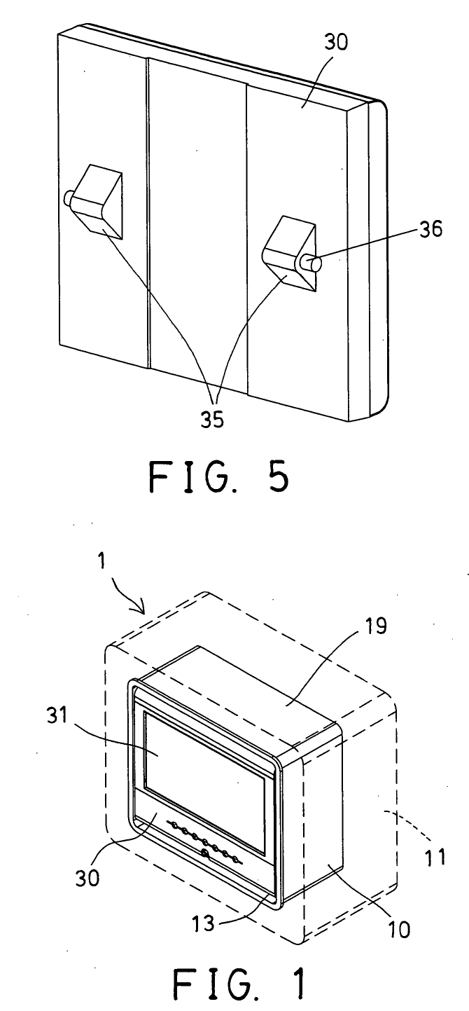

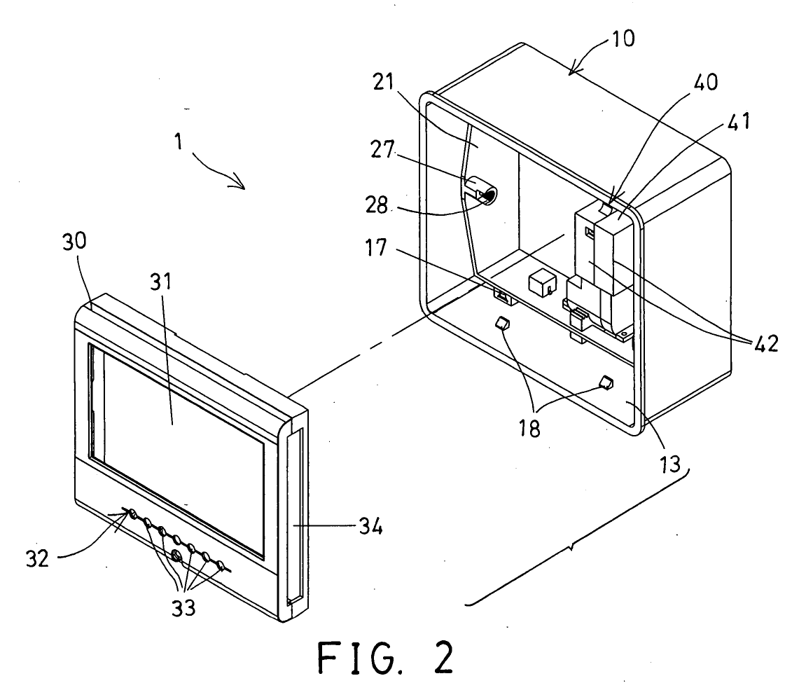

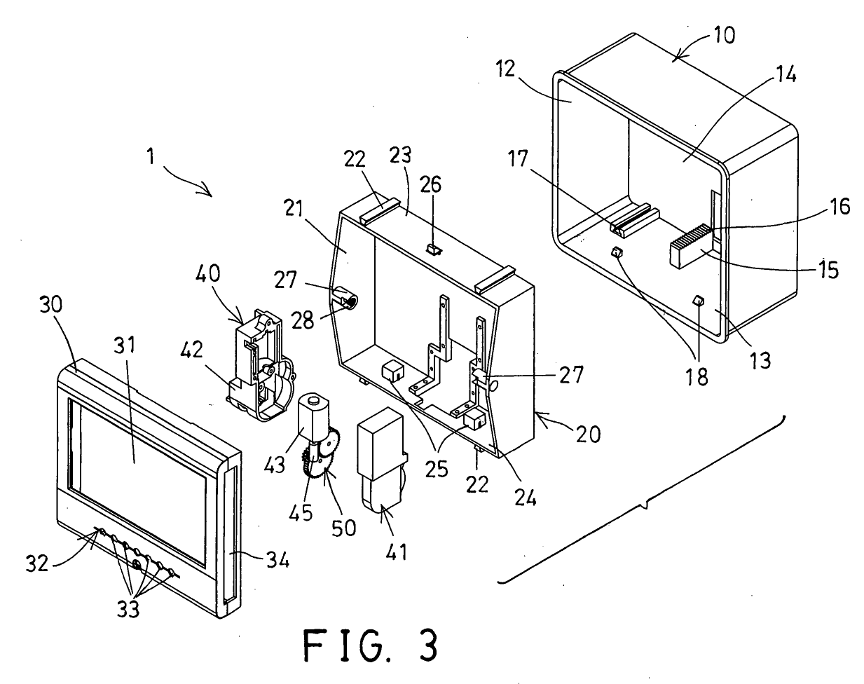

Referring to the drawings, and initially to FIGS. 1-4, a displayer mounting device 1 in accordance with the present invention comprises an outer receptacle 10 for attaching or mounting onto such as a seat back of a passenger vehicle (not shown) or the like, and the receptacle 10 may include an outer cushioning pad 11 engaged or attached onto the outer peripheral portion thereof (FIG. 1) for acting as a headrest for the passenger vehicle. The receptacle 10 includes a chamber 12 formed therein and includes a bottom wall 13 and a rear portion or rear wall 14.

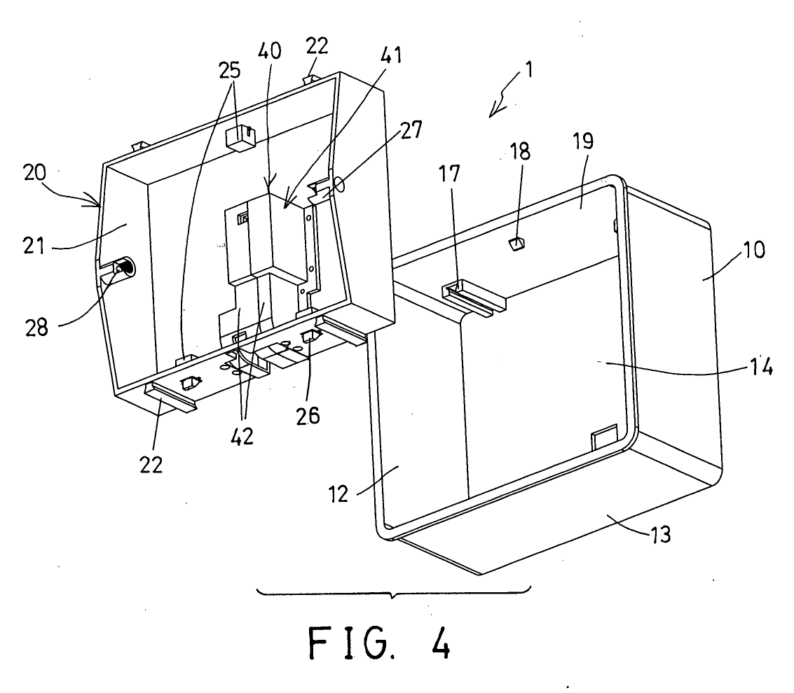

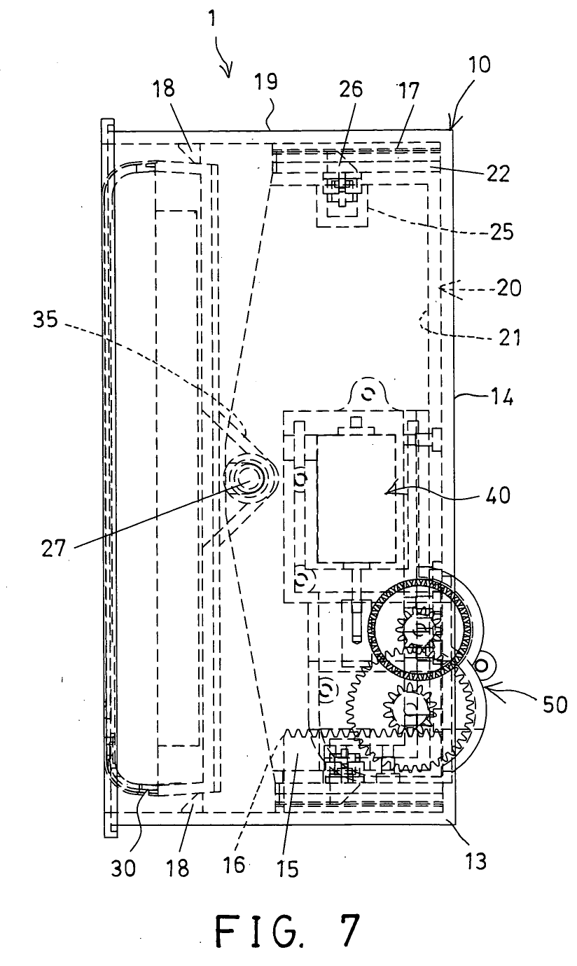

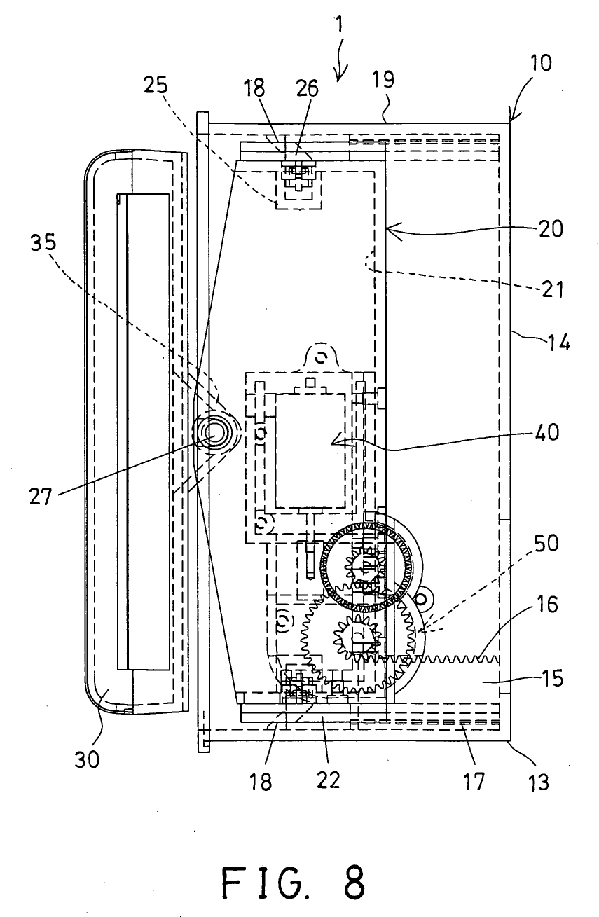

The receptacle 10 includes a rack 15 and one or more, such as two rails 17 and one or more, such as two stops 18 disposed on the bottom wall 13, and the rack 15 includes a number of teeth 16 formed on the upper portion. It is preferable that the rack 15 is disposed between the rails 17 and parallel to the rails 17, and the rack 15 and the rails 17 are located closer to the rear wall 14 than the stops 18. The receptacle 10 further includes one or more, such as two rails 17 and a stop 18 disposed on the upper wall 19, as shown in FIG. 4. It is preferable that the stops 18 include a triangular or wedge-shaped structure, best shown in FIGS. 7 and 8.

A housing 20 is slidably received in the chamber 12 of the receptacle 10 and includes a hollow space 21 formed therein, and includes one or more, such as two rails or bars 22 extended upwardly from an upper fence 23 and extended downwardly from a lower fence 24 respectively for slidably engaging with the rails 17 and for guiding the housing 20 to slide relative to the receptacle 10. One or more spring-biased catches 25 are attached to the inner portion of the upper fence 23 and the lower fence 24 of the housing 20 respectively and each includes a tongue 26 extended out through the upper fence 23 and the lower fence 24 of the housing 20 respectively for engaging with the stops 18 and for limiting the housing 20 to slide relative to the receptacle 10. The triangular or wedge-shaped stops 18 are arranged to allow the tongues 26 of the spring-biased catches 25 to move or engage over the stops 18 when the housing 20 moves into the receptacle 10, and to prevent the tongues 26 of the spring-biased catches 25 from moving or engaging over the stops 18 when the housing 20 moves outwardly relative to the receptacle 10.

The housing 20 includes one or more, such as two pegs or studs 27 oppositely extended into the space 21 of the housing 20, and the studs 27 each includes a cavity 28 formed therein. The housing 20 further includes an opening 29 formed in the lower fence 24 thereof. A monitor or display 30 includes a screen 31 formed or provided in the front portion thereof, and includes an entering device 32 formed or provided in the lower portion thereof and located below the screen 31, and includes a slot 34 formed in the side portion thereof for engaging a card, a portable disc, a floppy disc, a compact disc, or the like into the display 30.

As shown in FIG. 5, the display 30 includes one or more, such as two protrusions 35 extended rearwardly from the rear portion of the display 30 and the protrusions 35 each includes an axle 36 extended therefrom for rotatably engaging into the cavities 28 of the studs 27 of the housing 20, and for rotatably attaching or mounting the display 30 to the housing 20, and arranged for allowing the display 30 to be slightly rotated relative to the housing 20 also best shown in FIGS. 7 and 8. The display 30 may also be moved or slid relative to the receptacle 10 together with the housing 20 or by the housing 20.

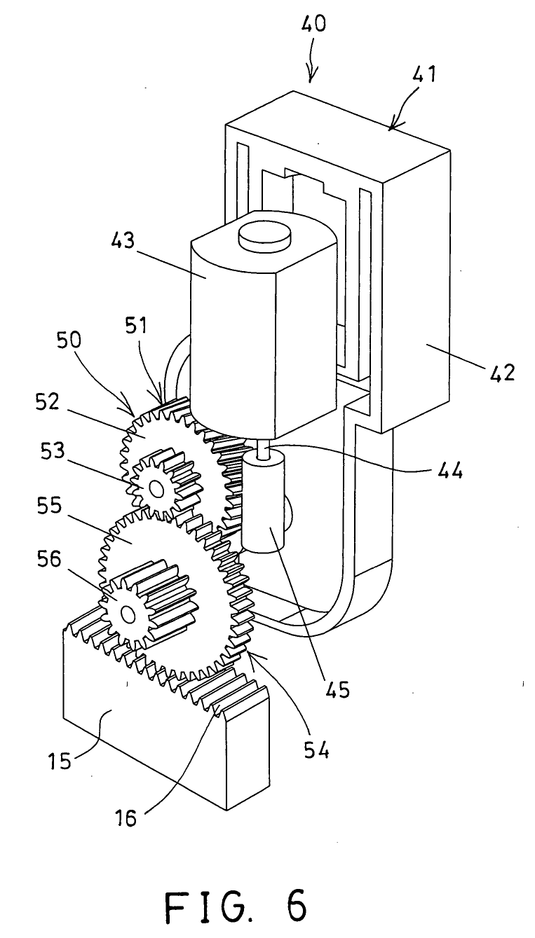

As best shown in FIG. 6, a driving device 40 includes a casing 41 disposed in the space 21 of the housing 20, and attached or mounted to the housing 20 with such as fasteners or latches (not shown), or by adhesive materials or by welding processes. The casing 41 may include one or more casing members 42 secured together. The driving device 40 further includes a driving member, such as motor 43 disposed in the casing 41, and the motor 43 includes a spindle 44 having a worm gear or an engaging member 45 attached to the free end portion of the spindle 44, and a reduction gearing 50 is also disposed in the casing 41 and engaged with the spindle 44 or the engaging member 45 of the motor 43 and the rack 15.

For example, the reduction gearing 50 includes a first gear set 51 having a gear 52; and a pinion 53 secured together or formed integral with each other, and the gear 52 is engaged or meshed with the spindle 44 or the engaging member 45 of the motor 43. The reduction gearing 50 further includes a second gear set 54 having a gear 55 and a pinion 56 secured together or formed integral with each other, and the gear 55 is engaged or meshed with the pinion 53 of the first gear set 51 and engaged or meshed with the teeth 16 of the rack 15, or the pinion 56 may alternatively be engaged or meshed with the teeth 16 of the rack 15. The gear 55 of the second gear set 54 is extended out of the casing 41 or is exposed through the opening 29 of the housing 20 for engaging or meshing with the rack 15. Or, the rack 15 is extended into or through the opening 29 of the housing 20 for engaging or meshing with the gear 55 of the second gear set 54.

The entering device 32 of the display 30 may include one or more keys or buttons 33, such as a display button, a stop button, a forward button, a rearward button, an electric power switch button, a moving button 33 and the other control buttons 33, for viewing or for controlling the programs or videos through the display 30, and/or for controlling the display 30 and the housing 20 to move or to slide relative to the receptacle 10.

In operation, as shown in FIGS. 7 and 8, when such as the moving button 33 of the entering device 32 is depressed or actuated by the user, the motor 43 may be energized to rotate or to drive the reduction gearing 50 with the spindle 44 or the engaging member 45 of the motor 43, and the housing 20 and thus the display 30 may be caused to move or to slide relative to the receptacle 10 due to the engagement between the reduction gearing 50 and the rack 15. The display 30 may thus be selectively moved out of the receptacle 10 for viewing or operating purposes (FIG. 8), or may be selectively moved into the receptacle 10 for storing purposes (FIG. 7). The stops 18 may be the microswitches for engaging with the tongues 26 of the spring-biased catches 25 and thus for limiting the housing 20 to slide relative to the receptacle 10.

It is to be noted that the displayer mounting device 1 is disposed or engaged within the outer receptacle 10 that may be provided for attaching or mounting onto the seat back of the passenger vehicle and for acting as the headrest for the passenger vehicle, such that the displayer mounting device 1 will not occupy the other spaces of the passenger vehicle, and such that the displayer mounting device 1 will not affect the passengers of the passenger vehicle at all. The driving device 40 and/or the housing 20 may thus be formed as a driving or moving means for driving or moving the housing 20 and the display 30 relative to the receptacle 10.

Accordingly, the displayer mounting device may be provided for attaching or mounting video monitors or video players or displayers to passenger vehicles without occupying spaces of the passenger vehicles, and without affecting the seating of the passengers within the passenger vehicles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A displayer mounting device for attaching to a vehicle, said displayer mounting device comprising:
a receptacle for attaching to the vehicle and for acting as a headrest for the vehicle, and including a chamber formed therein,
a display, and
a moving means for moving said display relative to said receptacle, to selectively move said display out of said chamber of said receptacle for operating purpose, or for selectively moving said display into said chamber of said receptacle for storing purpose.

2. The displayer mounting device as claimed in claim 1, wherein said moving means includes a housing slidably received in said chamber of said receptacle, said display is attached to said housing, and a driving means for driving said housing to move relative to said receptacle.

3. The displayer mounting device as claimed in claim 2, wherein said display is pivotally attached to said housing with at least one axle for allowing said display to be rotated relative to said housing.

4. The displayer mounting device as claimed in claim 3, wherein said housing includes at least one stud having a cavity formed therein for receiving said at least one axle and for pivotally attaching said display to said housing.

5. The displayer mounting device as claimed in claim 2, wherein said receptacle includes at least one stop extended into said chamber thereof, said housing includes at least one tongue for engaging with said at least one stop and for limiting said housing to slide relative to said receptacle.

6. The displayer mounting device as claimed in claim 5, wherein said housing includes at least one spring-biased catch having said at least one tongue extended out through said housing and for engaging with said at least one stop of said receptacle.

7. The displayer mounting device as claimed in claim 2, wherein said receptacle includes at least one rail extended into said chamber thereof, said housing includes at least one bar for engaging with said at least one rail and for guiding said housing to slide relative to said receptacle.

8. The displayer mounting device as claimed in claim 1, wherein said driving means includes a rack disposed in said receptacle, a reduction gear disposed in said housing and engaged with said rack of said receptacle, and a rotating means for rotating said reduction gear to move and to slide said housing relative to said receptacle.

9. The displayer mounting device as claimed in claim 8, wherein said rotating means includes a motor attached to said housing and engaged with said reduction gear for rotating said reduction gear.

10. The displayer mounting device as claimed in claim 9, wherein said motor includes a spindle having an engaging member attached to said spindle for engaging with said reduction gearing.

11. The displayer mounting device as claimed in claim 8, wherein said housing includes an opening for exposing said reduction gearing and for allowing said reduction gearing to be engaged with said rack.
